(19) United States
(12) Patent Application Publication
(10) Pub. No.: US 2016/0330149 A1
(43) Pub. Date: Nov. 10, 2016

(54) METHOD FOR PROVIDING POINT OF CONVERGENCE IN REAL TIME

(71) Applicants: Lahari SURAPANENI, Anaheim Hills, CA (US); Nishant Venkat SURAPANENI, Anaheim Hills, CA (US); Leena Sri SURAPANENI, Anaheim Hills, CA (US)

(72) Inventors: Lahari SURAPANENI, Anaheim Hills, CA (US); Nishant Venkat SURAPANENI, Anaheim Hills, CA (US); Leena Sri SURAPANENI, Anaheim Hills, CA (US)

(21) Appl. No.: 15/147,156

(22) Filed: May 5, 2016

Related U.S. Application Data
(60) Provisional application No. 62/158,764, filed on May 8, 2015.

(51) Int. Cl. H04L 12/58; G01C 21/34; G06Q 10/10; G06F 17/30; H04W 4/02; H04W 4/06

(52) U.S. Cl. CPC H04L 51/046; H04W 4/025; H04W 4/06; G06Q 10/1095; G06F 17/30241; G01C 21/3438

(57) ABSTRACT

The present invention relates to a method for participants or group of participants that facilitates scheduling and arriving at a pre-determined point of convergence in real time. More particularly, the present invention relates to a method for providing point of convergence in real time, where each participant tracks others and arrive at the point of convergence at pre-determined time thereby enabling group transit functionality. Advantageously, the present invention provides constant communication, visual interaction between group of participants enabling to schedule a location and time. Further, the present invention integrates selected destination and schedule date and time for the point of convergence with real time chatting application. A proposed route to the point of convergence is determined for each of the participants based on their respective locations once the request is accepted.

### FIELD OF THE INVENTION

The present invention relates to a point of convergence. Particularly, the present invention relates to a method for participants or group of participants that facilitates scheduling and arriving at a pre-determined point of convergence in real time. More particularly, the present invention relates to a method for providing point of convergence in real time, where each participant tracks others and arrive at the point of convergence at pre-determined time. Advantageously, the present invention provides constant communication, visual interaction between group of participants enabling to schedule a location and time. Further, the present invention integrates selected destination and schedule date and time for the point of convergence with real time chatting application.

### BACKGROUND OF THE INVENTION

Generally, instant messaging (IM) is a form of communication over a network such as the Internet that offers quick transmission of messages from sender to receiver. In push mode between two or more people using personal computers (PCs), mobile phones, smart phones or other devices, instant messaging basically offers real-time or quasi real time direct written language-based online chat. It may address point-to-point communications as well as multicast communications from one sender to many receivers.

Conventional instant messaging applications lack scheduling function that account for navigation based on a map and time sensitive tracking and lacks location services for the user to choose locations to meet. Once place and time is chosen every individual has to follow their own routes to arrive at a destination and does not have real time tracking of all participants based on their location and traffic conditions.

Some of the prior arts are: US20140336931 discloses providing a point of convergence comprising receiving a first geographic location of a first mobile device, receiving a second geographic location of a second mobile device, determining, based at least in part on the first geographic location and the second geographic location, a geographic point of convergence for the first mobile device and the second mobile device. in response to receiving an instruction from one or more of the first mobile device and the second mobile device to determine the geographic point of convergence, first instructions are provided to the first mobile device for navigating toward the geographic point of convergence, and second instructions are provided to the second mobile device for navigating toward the geographic point of convergence.

US20110113148 discloses a method for providing a meeting point and routes for participants to a proposed meeting including causing determination of locations of participants to a proposed meeting. The method further includes determining a meeting point and proposed routes of the participants to the meeting point based on the locations of the participants; and electronically providing to the participants, the meeting point and the proposed routes for display.

US8577589 discloses a method for providing a location information-based scheduling service, said method includes determining a meeting point or appointed place based on location information associated with a plurality of portable terminals. The method further includes suggesting various routes and means to travel to the appointed place; and providing data content to a user of a first portable terminal until one or more users associated with the other portable terminals arrive at the appointed place. However, the selected destination and schedule date and time for the point of convergence are not integrated with real time chatting application.

Accordingly, there exists a need for a method for providing point of convergence in real time, where each participant tracks others and arrive at the point of convergence at pre-determined time.

### OBJECTS OF THE INVENTION

One or more of the problems of the conventional prior art may be overcome by various embodiments of the present invention.

It is the primary object of the present invention to provide a method for participants or group of participants that facilitates scheduling and arriving at a pre-determined point of convergence in real time.

It is another object of the present invention to provide a method for providing point of convergence in real time, where each participant tracks others and arrive at the point of convergence at pre-determined time thereby enabling group transit functionality.

It is another object of the present invention, wherein the method integrates selected destination and schedule date and time for the point of convergence with real time chatting application. It is another object of the present invention, wherein the method eliminates waiting time of the participants, who waits without knowledge of estimated time of arrival and distance of the other participants from their destination.

It is another object of the present invention, wherein the method provides constant communication, visual interaction between group of participants enabling to schedule a location and time.

It is another object of the present invention, wherein current location of each participant is visible to all of the participants on the integrated map database with estimated times of arrival for each individual.

It is another object of the present invention, wherein schedule date and time for the point of convergence can be changed in real time by one of the participant after receiving confirmation from all other participants.

It is another object of the present invention, wherein the method further navigates the participants to the point of convergence in real time.

### SUMMARY OF THE INVENTION

Thus according to the basic aspect of the present invention there is provided a method for providing point of convergence in real time for participants or group of participants comprising the steps of:
broadcasting point of convergence request by a participant to other participants using a communication module;
selecting destination for the point of convergence through an integrated map database irrespective of location of each of the participants;
creating a schedule date and time for the point of convergence;
determining a proposed route to the point of convergence for each of the participants based on their respective locations once the request is accepted;
sending alert message to all the participants ahead of the scheduled time; tracking the locations of the participants traveling to the point of convergence in real time;
exchanging respective locations of the participants via the communication module;
presenting alternate directions on the integrated map database based on real-time traffic conditions to each participant; and
enabling all the participants to reach the point of convergence at scheduled time,
wherein the selected destination and schedule date and time for the point of convergence are integrated with real time chatting application, and
wherein the alert message is sent to all the participants prior to start time by calculating each individual participant location ahead of the scheduled time.

It is another aspect of the present invention, wherein each participant tracks other participants and arrives at the point of convergence at pre-determined time thereby enabling group transit functionality.

It is another aspect of the present invention, wherein depending on traffic conditions the alert is sent at pre-determined time before start in addition to the travel time based on real-time traffic conditions to each participant to begin their transit.

It is another aspect of the present invention, wherein current location of each participant is visible to all of the participants on the integrated map database with estimated times of arrival for each individual.

It is another aspect of the present invention, wherein if the participants are progressing to the destination after the scheduled time, alternate directions are suggested to all participants based on their current location through alerts.

It is another aspect of the present invention, wherein if one or more participants could not reach at the point of convergence at scheduled time, optimal route is determined based on the continuous evaluation of location of all the participants with current traffic conditions.

It is another aspect of the present invention, wherein in the event of adverse traffic condition prevailing for some participants, alternate location for the point of convergence is provided once agreed by all other participants, based on said participant's current location to arrive at initially scheduled time.

It is another aspect of the present invention, wherein all the participants are routed to the alternate location for the point of convergence and tracked in real time thereby eliminating the waiting time of the participants for the others.

It is another aspect of the present invention, wherein the method enables all the participants to arrive at scheduled time even though adverse traffic condition prevails for some participants.

It is another aspect of the present invention, wherein schedule date and time for the point of convergence can be changed in real time by one of the participant within the chatting application after receiving confirmation from all other participants.

It is another aspect of the present invention, wherein the schedule date and time is synchronized with existing calendar application of the respective communication module.

### BRIEF DESCRIPTION OF THE DRAWINGS

FIG. 1: illustrates the block diagram showing method of providing point of convergence according to the present invention.

FIG. 2: illustrates the method of creating a schedule date and time for the point of convergence according to the present invention.

FIG. 3: illustrates the method of tracking the locations of the participants according to the present invention.

FIG. 4: illustrates the flow chart showing the method for providing point of convergence according to the present invention.

FIG. 5: illustrates the method of communication in communication system for the point of convergence according to the present invention.

FIG. 6: illustrates the method of providing point of convergence according to the present invention.

### DETAILED DESCRIPTION OF THE INVENTION WITH REFERENCE TO THE ACCOMPANYING FIGURES

The present invention is thus directed to a method for participants or group of participants that facilitates scheduling and arriving at a pre-determined point of convergence in real time. More particularly, the present invention relates to a method for providing point of convergence in real time, where each participant tracks others and arrive at the point of convergence at pre-determined time. Advantageously, the present invention provides constant communication, visual interaction between group of participants enabling to schedule a location and time.

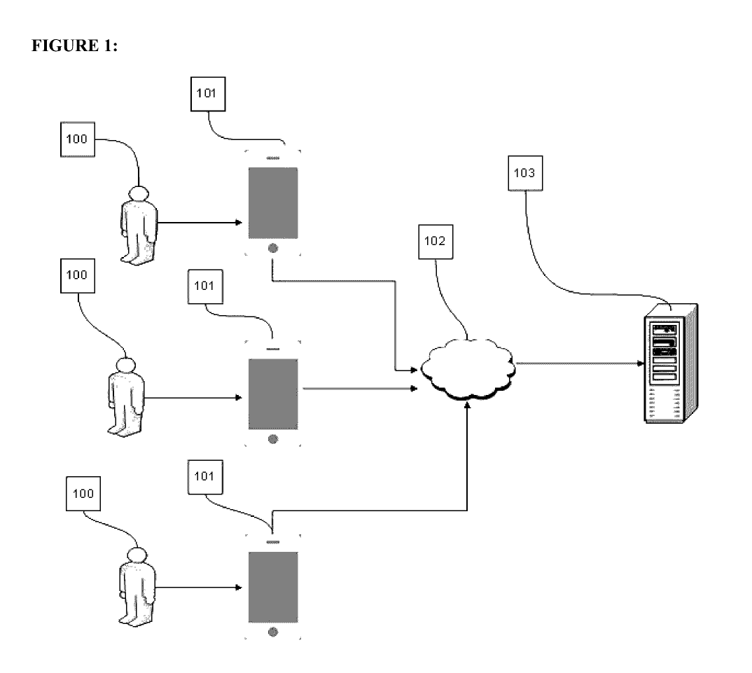

Referring to FIGS. 1 to 6, a method for providing point of convergence in real time for participants or group of participants [100] is as follows: point of convergence request by a participant [100] is broadcasted to other participants [100] using a communication module [101]. The communication module [101] communicates with other participants [100] with Extensible Messaging and Presence Protocol (XMPP) server with Multi Utility Communication [103] through a wireless communication [102].

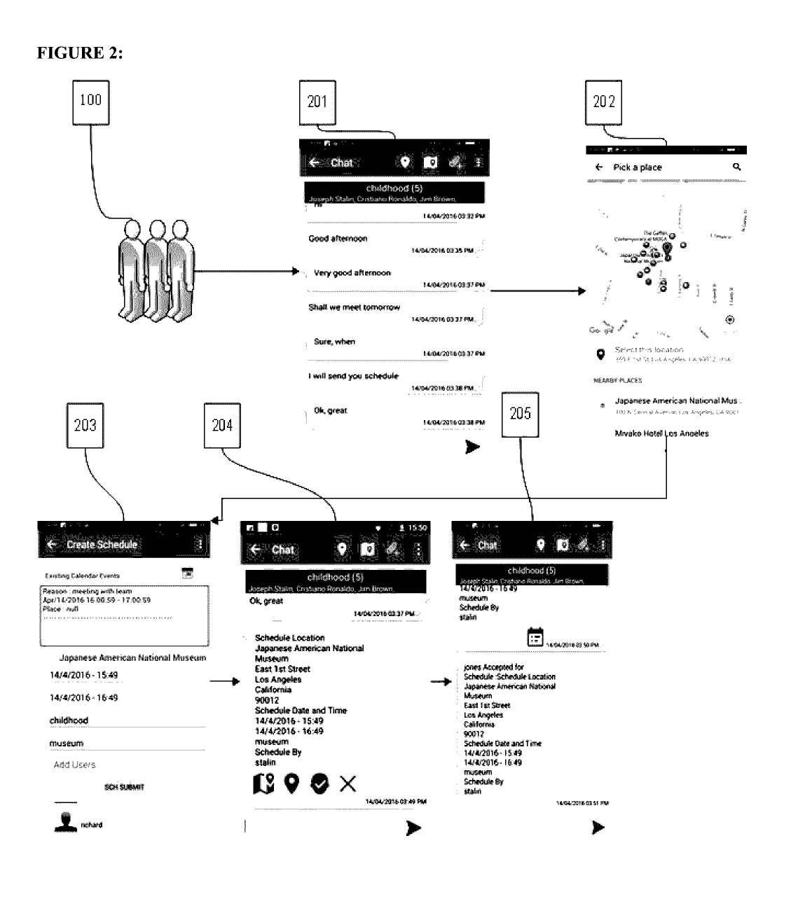

Destination for the point of convergence is selected through an integrated map database [202]. A schedule date and time [203] is created for the point of convergence. The selected destination and schedule date and time [203] for the point of convergence are integrated with real time chatting application [201] as shown in FIG. 2. A proposed route to the point of convergence is determined for each of the participants [100] based on their respective locations once the request

is accepted [205]. Alert message is sent to all the participants [100] ahead of the scheduled time [203]. Further, alarm [300] can be set by the participant [100] ahead of the scheduled time

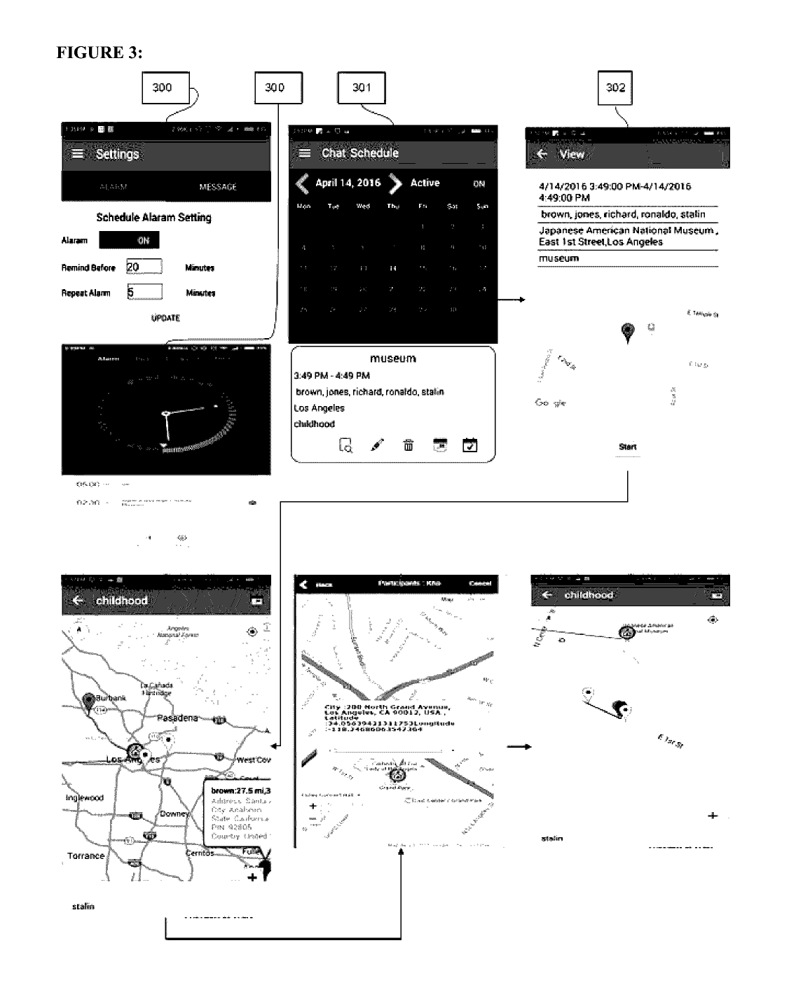

, once after accepting [205] the point convergence request [204]. The schedule date and time is also synchronized with existing calendar application [301] as shown in FIG. 3 of the respective communication module. The locations of the participants [100] traveling to the point of convergence are tracked in real time, said respective locations of the participants [100] are exchanged via the communication module [101].

The existing calendar events of the participants [100] can be visualized within the chat window to make sure new scheduled time at agreed on point of convergence is not conflicting with their existing schedules. The participant [100] can compare the agreed on point of convergence with their existing calendar events to see if intended group schedule is conflicting with his existing schedules, if so he can suggest alternate timings to the group and change the timings or if others cannot agree on the suggested changes he can reject the meeting. If not conflicting with the existing schedule, the participant can post the agreed up on group schedule to his communication module [101] or existing calendar and broadcast his acceptance to the group.

Alternate route/directions are presented on the integrated map database [202] based on real-time traffic conditions to each participant [100]. All the participants [100] are enabled to reach the point of convergence at scheduled time [203]. The alert message is sent to all the participants prior to start time by calculating each individual participant location ahead of the scheduled time. Depending on traffic conditions the alert is sent at pre-determined time before start in addition to the travel time based on real-time traffic conditions to each participant [100] as to when they have to begin their transit to arrive at the pre-determined location at the scheduled time [203]. Current location [302] of each participant [100] is visible to all of the participants [100] on the integrated map database [202] with estimated times of arrival for each individual.

If the participants [100] are progressing to the destination after the scheduled time [203], alternate routes/directions are suggested to all participants [100] based on their current location

through alerts. If one or more participants [100] could not reach at the point of convergence at scheduled time [203], shortest/optimal route is determined based on the continuous evaluation of location of all the participants [100] with current traffic conditions. In the event of adverse traffic condition prevailing for some participants [100], alternate/new location for the point of convergence is provided once agreed by all other participants, based on said participants [100] current location [302] to arrive at initially scheduled time [203]. All the participants [100] are routed to the alternate/new location for the point of convergence and tracked in real time thereby eliminating the waiting time of the participants [100] for the others.

The method enables all the participants to arrive at scheduled time [203] even though adverse traffic condition prevails for some participants. Schedule date and time [203] for the point of convergence can be changed in real time within the chatting application by one of the participant

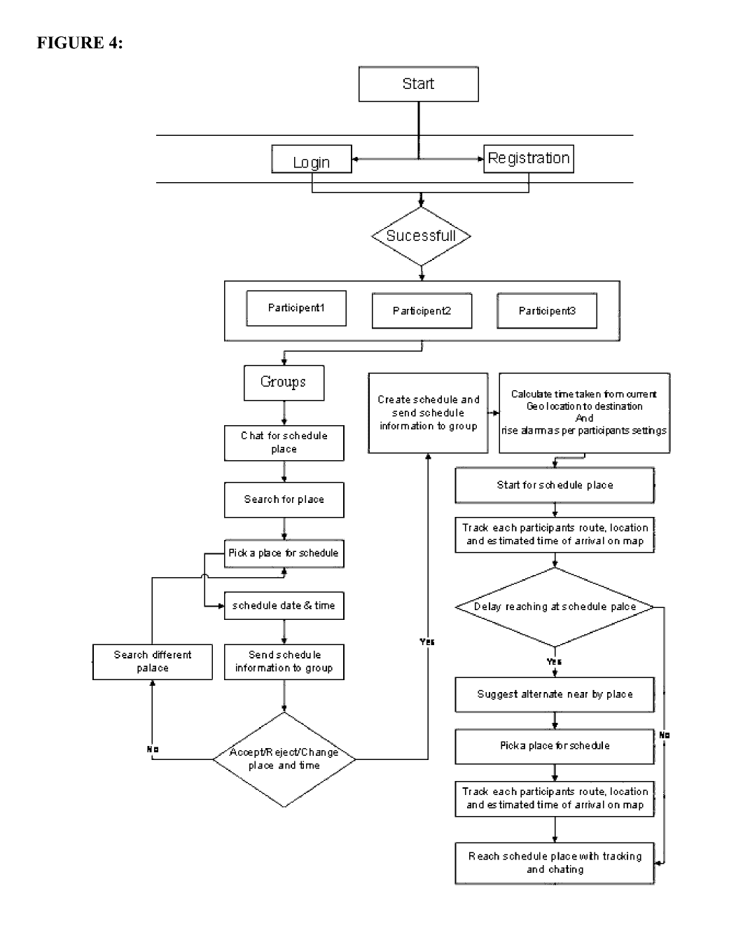

after receiving confirmation from all other participants [100]. The method further navigates the participants to the point of convergence in real time. Referring to FIG. 4 for illustration, each of the participants registers and login using their respective communication module. Each participant is linked to form a group in a chat based software application. Point of convergence request by a participant is broadcasted to other participants using a communication module. Destination for the point of convergence is searched and selected through an integrated map database. A schedule date and time is created for the point of convergence. The selected destination and schedule date and time for the point of convergence are integrated with real time chatting application. The schedule date and time is also synchronized with existing calendar application of the respective communication module. If the request is accepted/rejected/changed by the participant, same is conveyed to other participants via group chat. If the request is rejected by the participant, the participant can search and select different destination and schedule date and time.

A proposed route to the point of convergence is determined for each of the participants based on their respective locations once the request is accepted. Alert message is sent to all the participants ahead of the scheduled time. Further, alarm can be set by the participant ahead of the scheduled time, once after accepting the point convergence request. The locations of the participants traveling to the point of convergence are tracked in real time through the integrated map database, said respective locations of the participants are exchanged via the communication module. If the participants are progressing to the destination after the scheduled time, alternate routes/directions are suggested to all participants based on their current location through alerts. If one or more participants could not reach at the point of convergence at scheduled time, shortest/optimal route is determined based on the continuous evaluation of location of all the participants with current traffic conditions.

In the event of adverse traffic condition prevailing for some participants, alternate/new location for the point of convergence is provided once agreed by all other participants, based on said participants current location to arrive at initially scheduled time. The method further navigates the participants to the point of convergence in real time. All the participants are routed to the alternate/new location for the point of convergence and tracked in real time thereby eliminating the waiting time of the participants for the others.

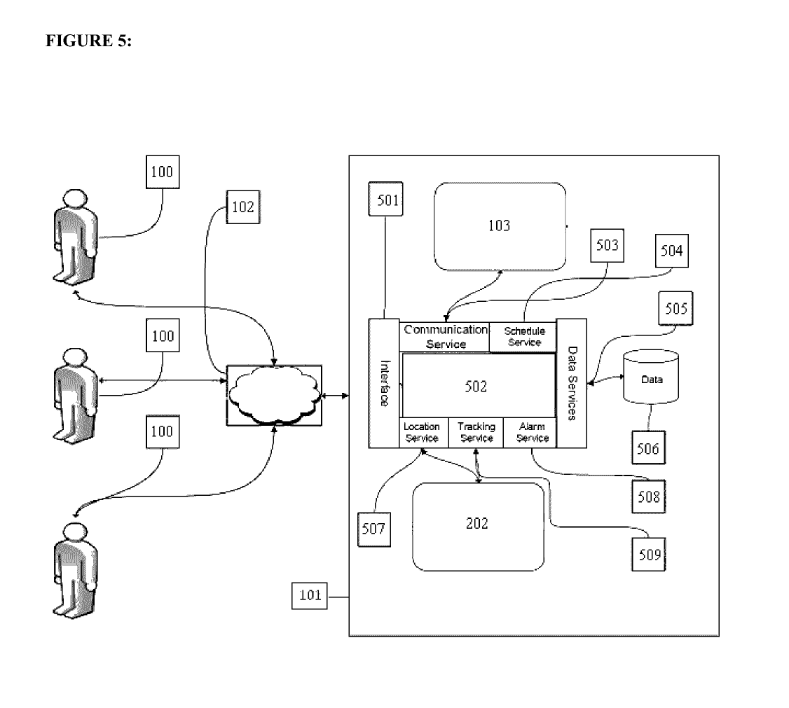

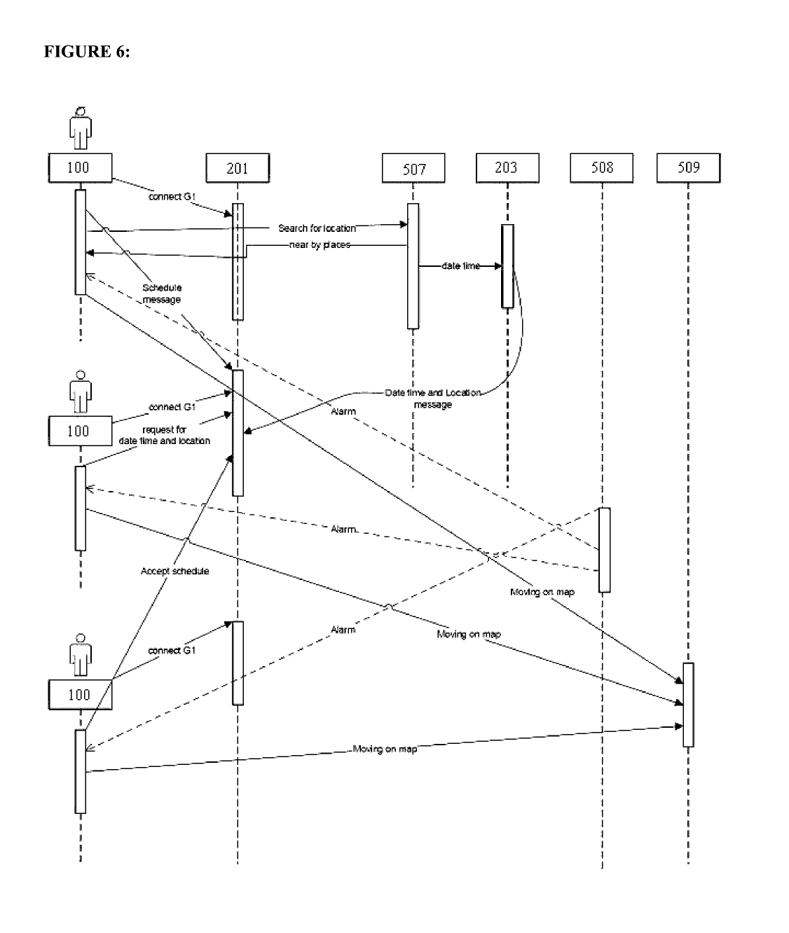

The communication module [101] further comprises of an interface [501]; Application Program Interface (API) [502]; communication service [503]; schedule service [504]; data service [505]; alarm service [508]; tracking service [509]; and location service [507] as shown in FIGS. 5 and 6. The Extensible Messaging and Presence Protocol (XMPP) server with Multi

Utility Communication [103] is connected with the communication service [504] for real time communication with multiple participants [100]. The integrated map database [202] is connected to the tracking service [509]. Data [506] of the users is connected to the data services [507].

Although the above provides a full and complete disclosure of the preferred embodiments of the invention, various modifications, variations and equivalents will occur to those skilled in the art. Therefore, the above should not be construed as limiting the invention, which is defined by the appended claims.

I claim:

1. A method for providing point of convergence in real time for participants or group of participants comprising the steps of:
broadcasting point of convergence request by a participant to other participants using a communication module;
selecting destination for the point of convergence through an integrated map database irrespective of location of each of the participants;
creating a schedule date and time for the point of convergence;
determining a proposed route to the point of convergence for each of the participants based on their respective locations once the request is accepted;
sending alert message to all the participants ahead of the scheduled time;
tracking the locations of the participants traveling to the point of convergence in real time;
exchanging respective locations of the participants via the communication module;
presenting alternate directions on the integrated map database based on real-time traffic conditions to each participant; and
enabling all the participants to reach the point of convergence at scheduled time, wherein the selected destination and schedule date and time for the point of convergence are integrated with real time chatting application, and
wherein the alert message is sent to all the participants prior to start time by calculating each individual participant location ahead of the scheduled time.

2. The method according to claim 1, wherein each participant tracks other participants and arrives at the point of convergence at pre-determined time thereby enabling group transit functionality.

3. The method according to claim 1, wherein depending on traffic conditions the alert is sent at pre-determined time before start in addition to the travel time based on real-time traffic conditions to each participant to begin their transit.

4. The method according to claim 2, wherein current location of each participant is visible to all of the participants on the integrated map database with estimated times of arrival for each individual.

5. The method according to claim 2, wherein if the participants are progressing to the destination after the scheduled time, alternate directions are suggested to all participants based on their current location through alerts.

6. The method according to claim 2, wherein if one or more participants could not reach at the point of convergence at scheduled time, optimal route is determined based on the continuous evaluation of location of all the participants with current traffic conditions.

7. The method according to claim 6, wherein in the event of adverse traffic condition prevailing for some participants, alternate location for the point of convergence is provided once agreed by all other participants, based on said participant's current location to arrive at initially scheduled time.

8. The method according to claim 7, wherein all the participants are routed to the alternate location for the point of convergence and tracked in real time thereby eliminating the waiting time of the participants for the others.

9. The method according to claim 7 enables all the participants to arrive at scheduled time even though adverse traffic condition prevails for some participants.

10. The method according to claim 9, wherein schedule date and time for the point of convergence can be changed in real time by one of the participant within the chatting application after receiving confirmation from all other participants.

11. The method according to claim 10, wherein the schedule date and time is synchronized with existing calendar application of the respective communication module.
